(19) United States
(12) Patent Application Publication
(10) Pub. No.: US 2026/0121325 A1
(43) Pub. Date: Apr. 30, 2026

(54) ELECTRICAL CONNECTOR WITH IMPROVED ROTATING COVER HAVING FIRST CAM AND SECOND CAM

(71) Applicant: DONGGUAN LEADER PRECISION INDUSTRY CO., LTD, Dongguan City (CN)

(72) Inventors: Zhongyuan LAI, Dongguan City (CN); Zhengguo SUN, Dongguan City (CN); Jinqi LI, Dongguan City (CN)

(73) Assignee: DONGGUAN LEADER PRECISION INDUSTRY CO., LTD, Dongguan City (CN)

(21) Appl. No.: 19/005,036

(22) Filed: Dec. 30, 2024

(30) Foreign Application Priority Data
Oct. 26, 2024 (CN) 202411508704.X

(51) Int. Cl. H01R 12/88; H01R 12/77

(52) U.S. Cl. CPC H01R 12/88; H01R 12/774

(57) ABSTRACT

An electrical connector includes an insulating body, a number of first conductive terminals, a number of second conductive terminals and a rotating cover. The insulating body defines a mating slot configured to receive an electrical connection element. The first conductive terminal includes a first contact elastic arm having a first contact portion. The second conductive terminal includes a second contact elastic arm having a second contact portion. The rotating cover is rotatable relative to the insulating body between an open position and a closed position. When the rotating cover rotates from the open position to the closed position, the rotating cover abuts against the first contact elastic arm and the second contact elastic arm, respectively, so that the first contact portion and the second contact portion are in close contact with the electrical connection element.

### CROSS-REFERENCE TO RELATED APPLICATION

This patent application claims priority of a Chinese Patent Application No. 202411508704.X, filed on Oct. 26, 2024 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

In the related art, there is an electrical connector for mating with an electrical connection element (for example, a flexible circuit board, FPC). The electrical connector includes an insulating body, a plurality of conductive terminals and a rotating cover. The rotating cover is rotatable between an open position and a closed position. When the flexible circuit board needs to be installed, the rotating cover is in an open state, thereby facilitating the insertion of the flexible circuit board into the electrical connector. After the flexible circuit board is inserted in place, the rotating cover is rotated to press the conductive terminals, so that the conductive terminals are in electrical contact with the flexible circuit board.

However, the rotating cover is easily subject to stress and becomes loose under some circumstances, thereby affecting the reliability of the connection between the electrical connector and the flexible circuit board.

### SUMMARY

An object of the present disclosure is to provide an electrical connector with an improved rotating cover to achieve higher reliability.

In order to achieve the above object, the present disclosure adopts the following technical solution: an electrical connector, including: an insulating body, the insulating body defining a mating surface and a mating slot extending through the mating surface along a first direction, the mating slot being configured to receive an electrical connection element; a plurality of first conductive terminals, the plurality of first conductive terminals being fixed to the insulating body; each first conductive terminal including a first fixing portion and a first contact elastic arm extending from the first fixing portion; the first contact elastic arm being provided with a first contact portion; a plurality of second conductive terminals, the plurality of second conductive terminals being provided on the insulating body; each second conductive terminal including a second fixing portion and a second contact elastic arm extending from the second fixing portion; the second contact elastic arm being provided with a second contact portion; the first contact portion and the second contact portion being spaced apart along the first direction; and a rotating cover, the rotating cover being rotatable relative to the insulating body between an open position and a closed position; the rotating cover including a first cam group and a second cam group; the first cam group including a plurality of first cams; the second cam group including a plurality of second cams; when the rotating cover rotates from the open position to the closed position, the first cam and the second cam abut against the first contact elastic arm and the second contact elastic arm, respectively, so that when the rotating cover reaches the closed position, both the first contact portion and the second contact portion are in close contact with the electrical connection element.

In order to achieve the above object, the present disclosure adopts the following technical solution: an electrical connector, including: an insulating body, the insulating body defining a mating surface and a mating slot extending through the mating surface along a first direction, the mating slot being configured to receive an electrical connection element; a plurality of first conductive terminals, each first conductive terminal including a first fixing portion assembled to the insulating body and a first contact elastic arm extending from the first fixing portion; the first contact elastic arm being provided with a first contact portion; a plurality of second conductive terminals, each second conductive terminal including a second fixing portion assembled to the insulating body and a second contact elastic arm extending from the second fixing portion; the second contact elastic arm being provided with a second contact portion; the first contact portion and the second contact portion being spaced apart along the first direction; and a rotating cover, the rotating cover being rotatable relative to the insulating body between an open position and a closed position; the rotating cover including a first cam group and a second cam group; the first cam group including a plurality of first cams spaced apart on a first straight line along a second direction; the second cam group including a plurality of second cams spaced apart on a second straight line along the second direction; the second direction being perpendicular to the first direction; when the rotating cover rotates from the open position to the closed position, the first cams deform the first contact elastic arms and the second cams deform the second contact elastic arms, so that when the rotating cover reaches the closed position, both the first contact portions and the second contact portions press against and are in electrical connection with the electrical connection element.

Compared with the prior art, the electrical connector of the present disclosure includes the rotating cover which is rotatable relative to the insulating body between the open position and the closed position. The rotating cover includes the first cam group and the second cam group. The first cam group includes the plurality of first cams. The second cam group includes the plurality of second cams. When the rotating cover rotates from the open position to the closed position, the first cam and the second cam abut against the first contact elastic arm and the second contact elastic arm, respectively, so that when the rotating cover reaches the closed position, both the first contact portion and the second contact portion are in close contact with the electrical connection element. With this arrangement, the electrical connector of the present disclosure has higher reliability.

### BRIEF DESCRIPTION OF DRAWINGS

FIG. 1 is a schematic perspective view of an electrical connector in accordance with an embodiment of the present disclosure;

FIG. 2 is a perspective view of FIG. 1 from another angle;

FIG. 3 is a front view of FIG. 1;

FIG. 4 is a rear view of FIG. 1;

FIG. 5 is a top view of FIG. 1;

FIG. 6 is a bottom view of FIG. 1;

FIG. 7 is a left view of FIG. 1;

FIG. 8 is a right view of FIG. 1;

FIG. 9 is a partially exploded perspective view of FIG. 1;

FIG. 10 is a partially exploded perspective view of FIG. 9 from another angle;

FIG. 11 is a right view of a first conductive terminal and a second conductive terminal in FIG. 9 when they are separated from each other;

FIG. 12 is a schematic cross-sectional view of the electrical connector of the present disclosure taken along a first section, in which a rotating cover is in an open position;

FIG. 13 is a schematic cross-sectional view of the electrical connector of the present disclosure taken along a second section, in which the rotating cover is in the open position;

FIG. 14 is a schematic cross-sectional view of the electrical connector of the present disclosure taken along the first section, in which the rotating cover is in a closed position; and

FIG. 15 is a schematic cross-sectional view of the electrical connector of the present disclosure taken along the second section, in which the rotating cover is in the closed position.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

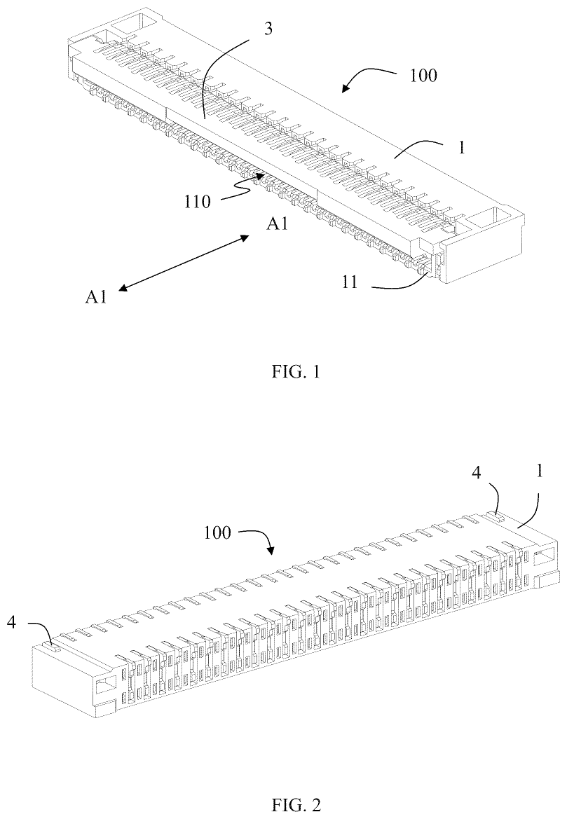

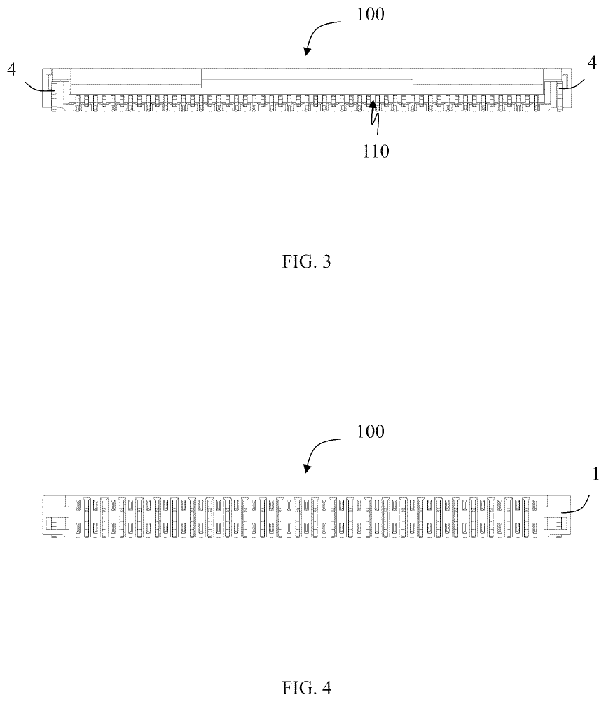

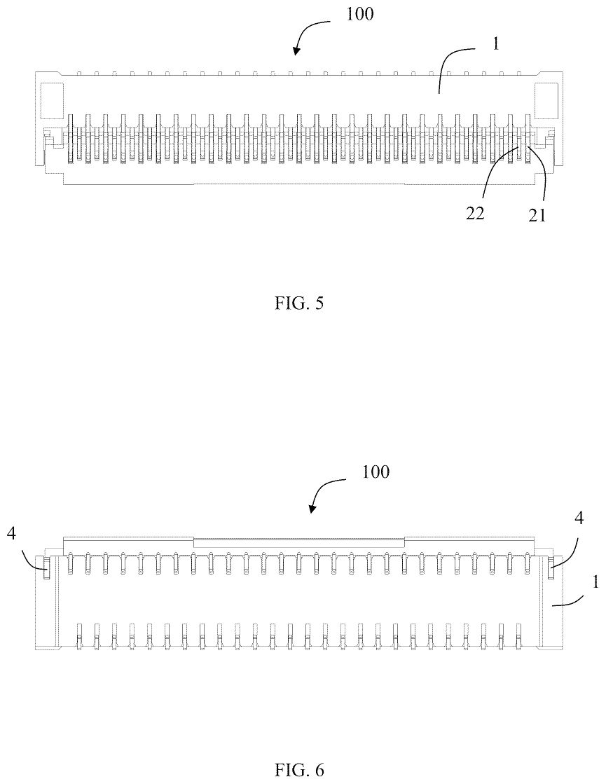

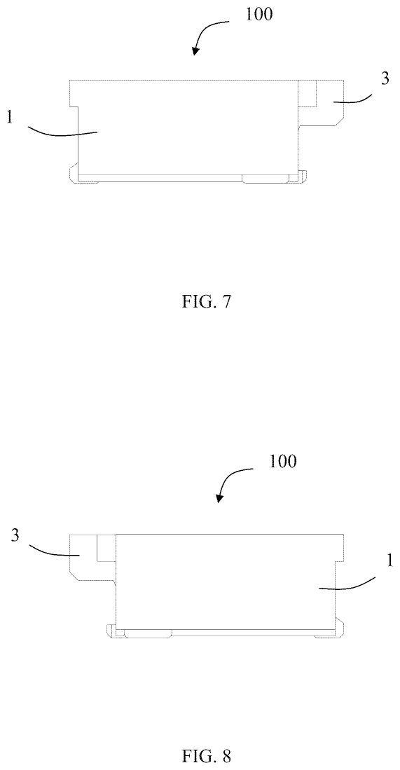

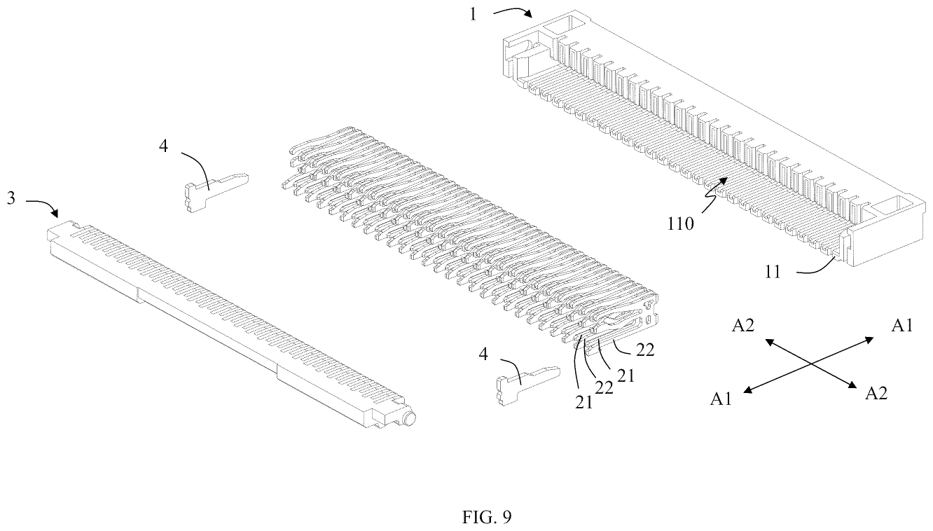

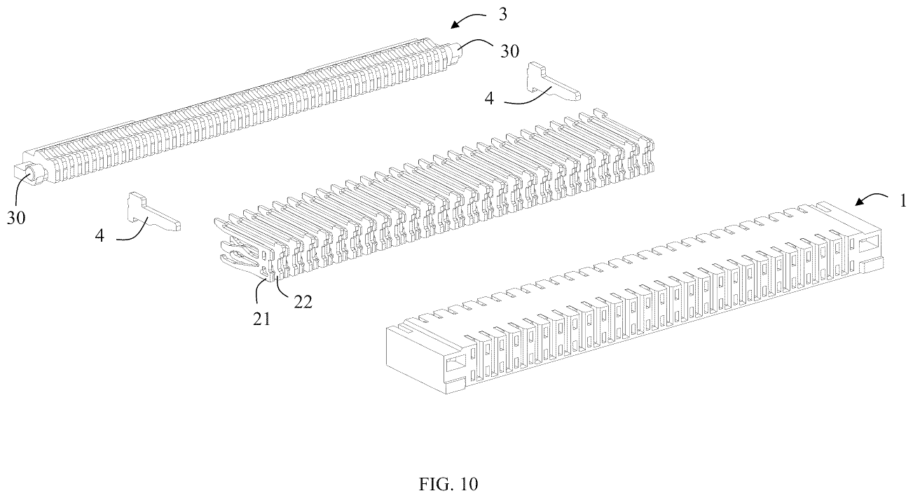

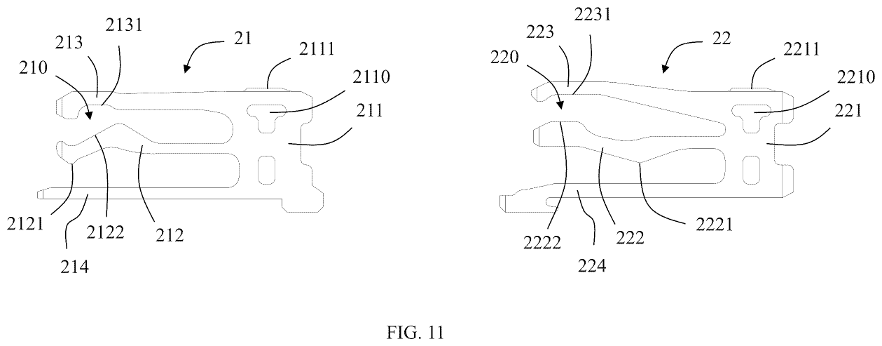

Referring to FIG. 1 to FIG. 15, the present disclosure discloses an electrical connector 100 for mating with an electrical connection element. The electrical connection element includes but is not limited to a flexible flat cable (FFC) or a flexible circuit board (FPC). A surface of the electrical connection element is provided with a plurality of conductive portions that are configured to be in electrical contact with the electrical connector 100. The electrical connector 100 includes an insulating body 1, a plurality of first conductive terminals 21 fixed to the insulating body 1, a plurality of second conductive terminals 22 fixed to the insulating body 1, a rotating cover 3 mounted to the insulating body 1, and a plurality of holding pieces 4 fixed to the insulating body 1.

In the illustrated embodiment of the present disclosure, the insulating body 1 defines a mating surface 11 and a mating slot 110 extending through the mating surface 11 along a first direction A1-A1 (for example, a front-rear direction). The mating slot 110 is configured to receive the electrical connection element.

The first conductive terminal 21 is provided on the insulating body 1. The first conductive terminal 21 includes a first fixing portion 211, a first contact elastic arm 212 extending from the first fixing portion 211, a first abutting elastic arm 213 extending from the first fixing portion 211, a first supporting portion 214 extending from the first fixing portion 211, and a first receiving space 210 located between the first contact elastic arm 212 and the first abutting elastic arm 213. The first contact elastic arm 212 is provided with a first contact portion 2121.

The second conductive terminal 22 is provided on the insulating body 1. In an embodiment of the present disclosure, the first conductive terminal 21 and the second conductive terminal 22 are assembled to the insulating body 1 along opposite directions. The second conductive terminal 22 includes a second fixing portion 221, a second contact elastic arm 222 extending from the second fixing portion 221, a second abutting elastic arm 223 extending from the second fixing portion 221, a second supporting portion 224 extending from the second fixing portion 221, and a second receiving space 220 located between the second contact elastic arm 222 and the second abutting elastic arm 223. The second contact elastic arm 222 is provided with a second contact portion 2221. The first supporting portion 214 and the second supporting portion 224 are both fixed to the insulating body 1 and exposed to the mating slot 110. The first supporting portion 214 and the second supporting portion 224 are configured to support the electrical connection element.

In the illustrated embodiment of the present disclosure, the first contact portion 2121 and the second contact portion 2221 are spaced apart along the first direction A1-A1. The first contact portion 2121 and the second contact portion 2221 are also offset along the first direction A1-A1. Specifically, the first contact portions 2121 of the plurality of first conductive terminals 21 are disposed in a first row along a second direction A2-A2 (for example, a left-right direction). The second contact portions 2221 of the plurality of second conductive terminals 22 are disposed in a second row along the second direction A2-A2. The first row and the second row are parallel to each other. The second direction A2-A2 is perpendicular to the first direction A1-A1.

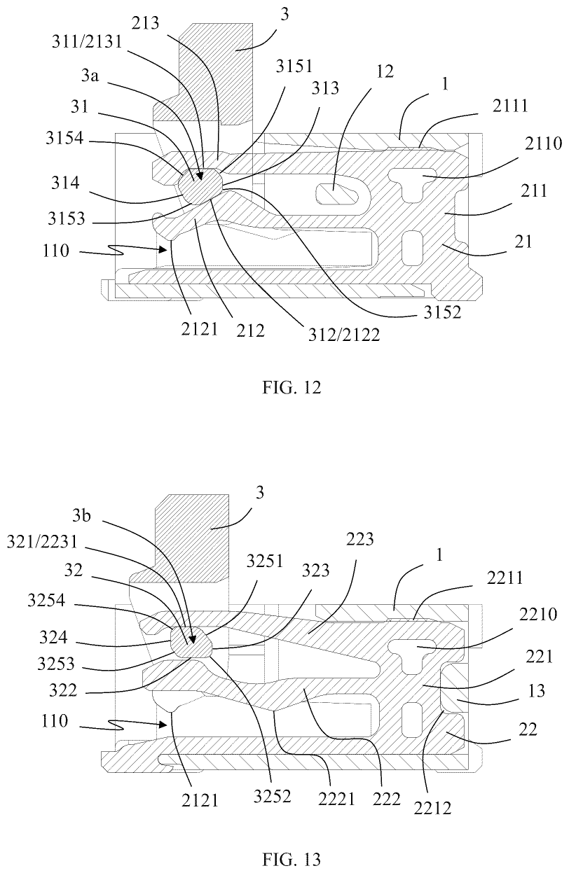

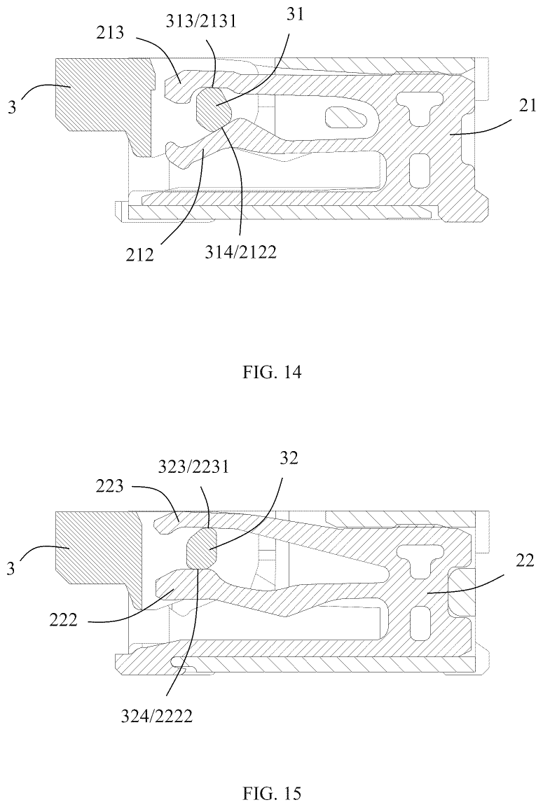

The rotating cover 3 is rotatable relative to the insulating body 1 between an open position (as shown in FIG. 12 and FIG. 13) and a closed position (as shown in FIG. 14 and FIG. 15). When the rotating cover 3 is in the best open position (for example, an upright state), the rotating cover 3 forms a vertical relationship with the rotating cover 3 in the best closed position (for example, a horizontal state). Pivots 30 are provided on two sides of the rotating cover 3, and the pivots 30 are rotatably mounted to the insulating body 1.

The rotating cover 3 includes a first cam group 3a and a second cam group 3b. The first cam group 3a includes a plurality of first cams 31 spaced apart on a first straight line along the second direction A2-A2. The second cam group 3b includes a plurality of second cams 32 spaced apart on a second straight line along the second direction A2-A2. The first straight line and the second straight line are different but parallel to each other. The first cam 31 is received in the first receiving space 210. The second cam 32 is received in the second receiving space 220.

When the rotating cover 3 rotates from the open position to the closed position, the first cam 31 and the second cam 32 abut against the first contact elastic arm 212 and the second contact elastic arm 222, respectively, and deform the first contact elastic arm 212 and the second contact elastic arm 222. As a result, when the rotating cover 3 reaches the closed position, both the first contact portion 2121 and the second contact portion 2221 are in close contact with the electrical connection element to achieve electrical connection. In one embodiment of the present disclosure, the first contact portion 2121 and the second contact portion 2221 press against the electrical connection element.

Specifically, in the illustrated embodiment of the present disclosure, the first abutting elastic arm 213 is provided with a first abutting flat surface 2131. The first contact elastic arm 212 is provided with a first abutting inclined surface 2122 facing away from the first contact portion 2121. The second abutting elastic arm 223 is provided with a second abutting flat surface 2231. The second contact elastic arm 222 is provided with a third abutting flat surface 2222 facing away from the second contact portion 2221.

In the illustrated embodiment of the present disclosure, the first cam 31 includes a first flat surface 311, a first inclined surface 312 disposed opposite to the first flat surface 311, a second flat surface 313 perpendicular to the first flat surface 311, a second inclined surface 314 disposed opposite to the second flat surface 313, a first arc-shaped surface 3151 connecting the first flat surface 311 and the second flat surface 313, a second arc-shaped surface 3152 connecting the second flat surface 313 and the first inclined surface 312, a third arc-shaped surface 3153 connecting the first inclined surface 312 and the second inclined surface 314, and a fourth arc-shaped surface 3154 connecting the second inclined surface 314 and the first flat surface 311. The first arc-shaped surface 3151, the second arc-shaped surface 3152, the third arc-shaped surface 3153 and the fourth arc-shaped surface 3154 are configured to abut against the corresponding first abutting elastic arm 213 or the first contact elastic arm 212 to achieve smooth rotation when the rotating cover 3 rotates from the open position to the closed position.

The second cam 32 includes a third flat surface 321, a fourth flat surface 322 disposed opposite to the third flat surface 321, a fifth flat surface 323 perpendicular to the third flat surface 321, a sixth flat surface 324 disposed opposite to the fifth flat surface 323, a fifth arc-shaped surface 3251 connecting the third flat surface 321 and the fourth flat surface 322, a sixth arc-shaped surface 3252 connecting the fifth flat surface 323 and the fourth flat surface 322, a seventh arc-shaped surface 3253 connecting the fourth flat surface 322 and the sixth flat surface 324, and an eighth arc-shaped surface 3254 connecting the sixth flat surface 324 and the third flat surface 321. The fifth arc-shaped surface 3251, the sixth arc-shaped surface 3252, the seventh arc-shaped surface 3253 and the eighth arc-shaped surface 3254 are configured to abut against the corresponding second abutting elastic arm 223 or the second contact elastic arm 222 to achieve smooth rotation when the rotating cover 3 rotates from the open position to the closed position.

Referring to FIG. 12 and FIG. 13, when the rotating cover 3 is in the open position, the first flat surface 311 of the first cam 31 is in contact with the first abutting flat surface 2131, and the first inclined surface 312 is in contact with the first abutting inclined surface 2122. The third flat surface 321 of the second cam 32 is in contact with the second abutting flat surface 2231. At this time, the first cam 31 abuts against the first abutting elastic arm 213 and the first contact elastic arm 212, and the second cam 32 abuts against the second abutting elastic arm 223, so as to maintain the rotating cover 3 in the open position. In other words, the rotating cover 3 of the present disclosure can maintain a hovering state at the open position. At the same time, the compressed contact force between the first conductive terminal 21 and the electrical connection element, and the compressed contact force between the second conductive terminal 22 and the electrical connection element are relaxed. The removal of electrical connection element can be performed with one hand, which is convenient and fast. Preferably, when the rotating cover 3 of the present disclosure is in the open position, the first conductive terminal 21 and the second conductive terminal 22 do not generate a pressing force on the electrical connection element, which facilitates the removal or insertion of the electrical connection element.

When the rotating cover 3 is in the closed position, the second flat surface 313 of the first cam 31 abuts against the first abutting flat surface 2131, and the second inclined surface 314 abuts against the first abutting inclined surface 2122. The fifth flat surface 323 of the second cam 32 abuts against the second abutting flat surface 2231, and the sixth flat surface 324 abuts against the third abutting flat surface 2222. At this time, the first cam 31 is clamped between the first abutting elastic arm 213 and the first contact elastic arm 212, and the second cam 32 is clamped between the second abutting elastic arm 223 and the second contact elastic arm 222, so as to maintain the rotating cover 3 in the closed position. The present disclosure provides the first cam 31 and the second cam 32. By two sets of cams abutting against the first conductive terminal 21 and the second conductive terminal 22, respectively, on the one hand, the rotating cover 3 can be maintained in a tightly closed state so that the rotating cover 3 is not easy to loosen; and on the other hand, the first contact portion 2121 and the second contact portion 2221 can achieve uniform pre-pressure contact with the conductive portions of the electrical connection element.

The first fixing portion 211 defines a first opening 2110 extending through the first fixing portion 211, and a first elastic interference portion 2111 located on one side of the first opening 2110 and protruding beyond the first abutting elastic arm 213. The first elastic interference portion 2111 elastically abuts against the insulating body 1.

The second fixing portion 221 defines a second opening 2210 extending through the second fixing portion 221, and a second elastic interference portion 2211 located on one side of the second opening 2210 and protruding beyond the second abutting elastic arm 223. The second elastic interference portion 2211 elastically abuts against the insulating body 1. In the illustrated embodiment of the present disclosure, the first opening 2110 and the second opening 2210 are both T-shaped.

By providing the first elastic interference portion 2111 and the second elastic interference portion 2211 which have a certain deformation capability, the present disclosure greatly reduces the overall deformation of the top and bottom surfaces of the insulating body 1 caused by the collection of local stresses due to hard interference. Besides, it also effectively prevents the risk of the terminals falling off due to hard interference damage to the slot contact surface of the insulating body 1.

In addition, the insulating body 1 includes a reinforcing protrusion 12 located between the first contact elastic arm 212 and the first abutting elastic arm 213 to improve the structural strength of the insulating body 1 and reduce deformation of the insulating body 1 as much as possible.

The second fixing portion 221 of the second conductive terminal 22 defines a retaining notch 2212 that extends backwardly through the second fixing portion 221 along the first direction A1-A1. The insulating body 1 accordingly includes a retaining protrusion 13 fixed in the retaining notch 2212.

Compared with the prior art, the electrical connector 100 of the present disclosure includes the rotating cover 3 which is rotatable relative to the insulating body 1 between the open position and the closed position. The rotating cover 3 includes the first cam group 3a and the second cam group 3b. The first cam group 3a includes the plurality of first cams 31. The second cam group 3b includes the plurality of second cams 32. When the rotating cover 3 rotates from the open position to the closed position, the first cam 31 and the second cam 32 abut against the first contact elastic arm 212 and the second abutting elastic arm 222, respectively. As a result, when the rotating cover 3 reaches the closed position, both the first contact portion 2121 and the second contact portion 2221 are in close contact with the electrical connection element. With this arrangement, the electrical connector 100 of the present disclosure has a stable reliability.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
an insulating body, the insulating body defining a mating surface and a mating slot extending through the mating surface along a first direction, the mating slot being configured to receive an electrical connection element;
a plurality of first conductive terminals, the plurality of first conductive terminals being fixed to the insulating body; each first conductive terminal comprising a first fixing portion and a first contact elastic arm extending from the first fixing portion; the first contact elastic arm being provided with a first contact portion;
a plurality of second conductive terminals, the plurality of second conductive terminals being provided on the insulating body; each second conductive terminal comprising a second fixing portion and a second contact elastic arm extending from the second fixing portion; the second contact elastic arm being provided with a second contact portion; the first contact portion and the second contact portion being spaced apart along the first direction; and
a rotating cover, the rotating cover being rotatable relative to the insulating body between an open position and a closed position; the rotating cover comprising a first cam group and a second cam group; the first cam group comprising a plurality of first cams; the second cam group comprising a plurality of second cams;
when the rotating cover rotates from the open position to the closed position, the first cam and the second cam abut against the first contact elastic arm and the second contact elastic arm, respectively, so that when the rotating cover reaches the closed position, both the first contact portion and the second contact portion are in close contact with the electrical connection element.

2. The electrical connector of claim 1, wherein the first contact portion and the second contact portion are offset along the first direction.

3. The electrical connector according to claim 1, wherein the first contact portions of the plurality of first conductive terminals are disposed in a first row along a second direction; the second contact portions of the plurality of second conductive terminals are disposed in a second row along the second direction; the first row and the second row are parallel to each other; the second direction is perpendicular to the first direction.

4. The electrical connector according to claim 1, wherein the first conductive terminal comprises a first abutting elastic arm extending from the first fixing portion, and a first receiving space located between the first contact elastic arm and the first abutting elastic arm; the first cam is received in the first receiving space;
the second conductive terminal comprises a second abutting elastic arm extending from the second fixing portion, and a second receiving space located between the second contact elastic arm and the second abutting elastic arm; the second cam is received in the second receiving space.

5. The electrical connector according to claim 4, wherein the first cam comprises a first flat surface and a first inclined surface disposed opposite to the first flat surface;
the first contact elastic arm comprises a first abutting surface; the first contact elastic arm comprises a first abutting inclined surface facing away from the first contact portion;
when the rotating cover is in the open position, the first flat surface is in contact with the first abutting flat surface; the first inclined surface is in contact with the first abutting inclined surface.

6. The electrical connector according to claim 5, wherein the first cam comprises a second flat surface perpendicular to the first flat surface and a second inclined surface disposed opposite to the second flat surface;
when the rotating cover is in the closed position, the second flat surface abuts against the first abutting flat surface, and the second inclined surface abuts against the first abutting inclined surface.

7. The electrical connector according to claim 6, wherein the first cam further comprises a first arc-shaped surface connecting the first flat surface and the second flat surface, a second arc-shaped surface connecting the second flat surface and the first inclined surface, a third arc-shaped surface connecting the first inclined surface and the second inclined surface, and a fourth arc-shaped surface connecting the second inclined surface and the first flat surface;
the first arc-shaped surface, the second arc-shaped surface, the third arc-shaped surface and the fourth arc-shaped surface are configured to abut against a corresponding first abutting elastic arm or a corresponding first contact elastic arm when the rotating cover rotates from the open position to the closed position.

8. The electrical connector according to claim 4, wherein the second cam comprises a third flat surface and a fourth flat surface disposed opposite to the third flat surface;
the second abutting elastic arm comprises a second abutting flat surface; the second contact elastic arm comprises a third abutting flat surface facing away from the second contact portion;
when the rotating cover is in the open position, the third flat surface is in contact with the second abutting flat surface.

9. The electrical connector according to claim 8, wherein the second cam comprises a fifth flat surface perpendicular to the third flat surface and a sixth flat surface faxing away from the fifth flat surface;
when the rotating cover is in the closed position, the fifth flat surface abuts against the second abutting flat surface, and the sixth flat surface abuts against the third abutting flat surface.

10. The electrical connector according to claim 9, wherein the second cam further comprises a fifth arc-shaped surface connecting the third flat surface and the fourth flat surface, a sixth arc-shaped surface connecting the fifth flat surface and the fourth flat surface, a seventh arc-shaped surface connecting the fourth flat surface and the sixth flat surface, and an eighth arc-shaped surface connecting the sixth flat surface and the third flat surface;
the fifth arc-shaped surface, the sixth arc-shaped surface, the seventh arc-shaped surface and the eighth arc-shaped surface are configured to abut against a corresponding second abutting elastic arm or a corresponding second contact elastic arm when the rotating cover rotates from the open position to the closed position.

11. The electrical connector according to claim 4, wherein when the rotating cover is in the open position, the first cam abuts against the first abutting elastic arm and the first contact elastic arm, and the second cam abuts against the second abutting elastic arm, so as to maintain the rotating cover in the open position.

12. The electrical connector according to claim 4, wherein when the rotating cover is in the closed position, the first cam is clamped between the first abutting elastic arm and the first contact elastic arm, and the second cam is clamped between the second abutting elastic arm and the second contact elastic arm, so as to maintain the rotating cover in the closed position.

13. The electrical connector according to claim 4, wherein the first fixing portion comprises a first opening extending through the first fixing portion, and a first elastic interference portion located on one side of the first opening and protruding beyond the first abutting elastic arm; the first elastic interference portion elastically abuts against the insulating body.

14. The electrical connector according to claim 13, wherein the second fixing portion comprises a second opening extending through the second fixing portion, and a second elastic interference portion located on one side of the second opening and protruding beyond the second abutting elastic arm; the second elastic interference portion elastically abuts against the insulating body.

15. The electrical connector according to claim 14, wherein the first opening and the second opening are T-shaped.

16. The electrical connector according to claim 4, wherein the first conductive terminals and the second conductive terminals are assembled to the insulating body along opposite directions;
the insulating body comprises a reinforcing protrusion located between the first contact elastic arms and the first abutting elastic arms.

17. The electrical connector according to claim 1, wherein the second fixing portion defines a retaining notch extending through the second fixing portion along the first direction;
the insulating body comprises a retaining protrusion fixed in the retaining notch.

18. An electrical connector, comprising:
an insulating body, the insulating body defining a mating surface and a mating slot extending through the mating surface along a first direction, the mating slot being configured to receive an electrical connection element;
a plurality of first conductive terminals, each first conductive terminal comprising a first fixing portion assembled to the insulating body and a first contact elastic arm extending from the first fixing portion; the first contact elastic arm being provided with a first contact portion;
a plurality of second conductive terminals, each second conductive terminal comprising a second fixing portion assembled to the insulating body and a second contact elastic arm extending from the second fixing portion; the second contact elastic arm being provided with a second contact portion; the first contact portion and the second contact portion being spaced apart along the first direction; and
a rotating cover, the rotating cover being rotatable relative to the insulating body between an open position and a closed position; the rotating cover comprising a first cam group and a second cam group; the first cam group comprising a plurality of first cams spaced apart on a first straight line along a second direction; the second cam group comprising a plurality of second cams spaced apart on a second straight line along the second direction; the second direction being perpendicular to the first direction;
when the rotating cover rotates from the open position to the closed position, the first cams deform the first contact elastic arms and the second cams deform the second contact elastic arms, so that when the rotating cover reaches the closed position, both the first contact portions and the second contact portions press against and are in electrical connection with the electrical connection element.

19. The electrical connector according to claim 18, wherein each first conductive terminal comprises a first abutting elastic arm extending from the first fixing portion, and a first receiving space located between the first contact elastic arm and the first abutting elastic arm; a corresponding first cam is received in the first receiving space;
each second conductive terminal comprises a second abutting elastic arm extending from the second fixing portion, and a second receiving space located between the second contact elastic arm and the second abutting elastic arm; a corresponding second cam is received in the second receiving space.

20. The electrical connector according to claim 18, wherein the first contact portions of the plurality of first conductive terminals are disposed in a first row along the second direction; the second contact portions of the plurality of second conductive terminals are disposed in a second row along the second direction; the first row and the second row are parallel to each other.
